(19) United States
(12) Patent Application Publication
(10) Pub. No.: US 2007/0298143 A1
(43) Pub. Date: Dec. 27, 2007

(54) RETARDER-TO-OVEN LAMINATED DOUGH

(76) Inventor: Graves John, St Paul, MN (US)

Correspondence Address: GENERAL MILLS, INC., P.O. BOX 1113, MINNEAPOLIS, MN, 55440, US

(21) Appl. No.: 11/750,140

(22) Filed: May 17, 2007

Related U.S. Application Data
(60) Provisional application No. 60/808,619, filed on Jun. 22, 2006.

(51) Int. Cl. A21D 8/00; A21D 10/02; A21D 8/02; A21D 8/06

(52) U.S. Cl. 426/19; 426/62

(57) ABSTRACT

A laminated dough having alternating layers of layer dough and shortening that can be frozen, stored, thawed in a retarder, and baked in an oven absent a distinct proofing step. The laminated dough includes vital wheat gluten of at least about 3% by weight of the layer dough. The elevated level of vital wheat gluten provides the layer dough with increased strength and gas holding capacity, which ultimately results in a higher baked specific volume than traditionally prepared laminated dough products. The elevated level of yeast increases the leavening rate during thawing, therefore eliminating the need for a distinct proofing step in a proof box before baking. Following baking, the resulting laminated dough product is similar in taste and visual appearance as a laminated dough product prepared with a traditional thaw, proof, and bake procedure. A baked product made from the laminated dough can have a baked specific volume of at least about 4 cc/g to about 6 cc/g.

### PRIORITY CLAIM

The present application claims priority to U.S. Provisional Application Ser. No. 60/808,619 filed May 26, 2007 and entitled “RETARDER-TO-OVEN LAMINATED DOUGH”, which is herein incorporated by reference to the extent not inconsistent with the present disclosure.

### FIELD OF THE INVENTION

The disclosure is generally directed to laminated dough compositions and related methods for making laminated dough products. More particularly, the disclosure is directed to a laminated dough composition that can be baked in an oven without requiring a distinct proofing step.

### BACKGROUND OF THE INVENTION

A variety of dough compositions and products require a standard method of preparing a final baked product to produce a desirable product. As depicted in FIG. 1, a standard method of preparation includes a freezing step 102, a thawing step 104, a skill-intensive proofing step 106, and a baking step 108. Proofing step 106 typically occurs prior to cooking (e.g., frying or baking) either before freezing step 102, or after thawing step 104. Proofing step 106 causes a dough composition to develop a light, airy dough matrix.

Yeast is a known dough ingredient that, among other things (ex., flavoring), can be used to produce a metabolic gas, such as, carbon dioxide to leaven and proof a dough composition to a suitable raw specific volume prior to cooking. Some dough compositions completely eliminate yeast-induced leavening by leavening a dough composition exclusively with chemical leavening agents. The chemical leavening agents, such as, a leavening acid and a leavening base, react to produce a leavening gas, such as, carbon dioxide. One drawback of chemical leavening is that chemical leavening agents often provide less desirable characteristics in a final cooked dough product as compared to a yeast-leavened dough product. For example, dough products leavened exclusively by chemical leavening agents may have a less desirable taste, texture, or aroma, compared to yeast-leavened dough products.

Dough compositions that rely exclusively on yeast for achieving a proofed raw specific volume conventionally carry out proofing at a specific humidity and an ambient temperature or temperatures above ambient (e.g., in a proof-box), but below cooking temperatures. A drawback of proofing a conventional dough at an ambient temperature, where the dough relies exclusively on yeast for achieving a proofed raw specific volume is that the proofing step may be too long to accommodate dough processing at a commercial level, such as, for example, large-volume food service customers and commercial bakeries. In order to promote yeast-based leavening, proofing equipment, or “proof-boxes,” are sometimes used to proof dough in an environment having a specific range of relative humidity, preferably at least 70%, and a temperature between ambient temperatures and below cooking temperatures. Typically, “proof boxes” can have a temperature between about 85-95° F. One drawback of proofing at such conditions is the cost of the equipment required to maintain the relative humidity and temperature within the desired ranges. Even with such equipment, temperature and humidity within a proof-box tends to fluctuate readily, with significant variation.

Another drawback is that dough compositions tend to be sensitive to changes in temperature and relative humidity when being proofed at elevated temperatures and relative humidity, thereby requiring skilled training and experience to successfully carry out the proofing operation. In addition, the length of proofing time can depend on the size of the product, the product formulation, the age of the product, and other factors. In many cases, the degree of proof is subjectively determined by the feel of the dough when poked with a finger. For example, if an indentation in the dough is made with the finger and then the indentation returns to its original position, the dough is not fully proofed. If an indentation is made and the dough springs back partway, the dough is ready to bake. If an indentation is made and the dough does not spring back at all, it may be over-proofed.

Often times, retailers need a baked product of a specific size to accommodate their packaging, making it critical for them to achieve ideal proofing performance. The window of time for ideally-proofed dough is relatively small compared to the total time of the proof cycle. For example, in an approximately 90-minute proof cycle, there is typically an ideal window of approximately 15 minutes in which the dough is ready to bake. Removing the dough before or after the ideal window results in either under-proofed or over-proofed dough. The finished baked product is often inconsistent and undesirable in terms of visual appearance, texture, and/or taste. Therefore, determining the degree of proof of product placed in a proof-box is an art requiring skilled training and experience.

However, many large-volume food service customers and commercial bakeries employ unskilled labor to reduce labor costs. Typically, the unskilled operators will proof the dough in a proof-box, relying solely on time and no other factors. As a result, there is a significant amount of variability in size and/or color of the finished baked product. Often times, the operators will forget to pull the product from the proof box within the window, and the resulting dough is over-proofed. Therefore, the proofing step is considered a “high-error” step for retailers.

One popular yeast-leavened dough product is a laminated dough product having alternating layers of dough and fat. Laminated dough compositions are sometimes frozen, for example, to store the dough composition for later processing or preserve dough compositions for longer periods. Many commercial frozen dough compositions, especially those that are yeast-leavened, are thawed prior to cooking. Frozen dough compositions that do not require a separate proofing step are also known in the art, such as, for example, U.S. Pat. No. 6,579,554, entitled, “Freezer-to-Oven, Laminated, Unproofed Dough and Products Resulting Therefrom”, which is herein incorporated by reference in its entirety.

Due to the popularity of laminated dough products, there remains an ongoing need to identify new, useful, and/or improved compositions and methods for making laminated dough compositions, especially for the food service industry, where it is desirable to reduce the amount of time, skill, and/or cost needed to process the laminated dough into a cooked product.

### SUMMARY

The disclosure is generally directed to a laminated dough for use in commercial facilities, such as, for example, commercial bakeries and cafeterias, that can be frozen, stored, thawed in a retarder, and baked in an oven without requiring a distinct proofing step, therefore reducing preparation time and variability in the finished baked product. Following baking, the resulting laminated dough product is similar in taste and visual appearance as a laminated dough product prepared with a traditional thaw, proof, and bake procedure.

In one aspect, a laminated dough can include a plurality of alternating layers of dough and shortening. Typically, the dough formed into layers (hereinafter referred to as “layer dough” for convenience) can include flour, water, protein supplement, such as, vital wheat gluten, and a leavening agent. The layer dough can include an elevated level of protein supplement, such as, vital wheat gluten compared to traditional laminated dough. The layer dough can then be sheeted, and the shortening is added to the sheeted dough. The layer dough and shortening are then subjected to multiple lapping and sheeting steps to form a laminated dough. In one aspect, a laminated dough of the disclosure is particularly advantageous because it prepares a desirable laminated baked product that has a baked specific volume of at least 4 cc/g. In another representative embodiment, a baked product can have a baked specific volume of about 4 cc/g to about 6 cc/g.

A protein supplement, such as, vital wheat gluten, can be added to a laminated dough of the invention to assist in increasing baked specific volume, therefore creating an airy baked product. Gluten aids in forming a three-dimensional structure, which provides strength to the layer dough. Gluten also has excellent gas holding capacity increasing the laminated dough's baked specific volume. The resulting layer dough can be stretched in all directions under the pressure of expanding gas created by the yeast during thawing and baking. The gluten also aids in creating a fairly rigid cellular structure, reflected by the laminated dough product's relatively high baked specific volume, as compared to prior formulations. For example, the baked specific volume of a laminated dough of the disclosure increases at least two times in the retarder from the baked specific volume of the frozen dough during the thawing step. In one aspect of the disclosure, vital wheat gluten can be present in a laminated dough at a minimum of about 3%, or from about 3.5% to about 4.5%, and further, in some embodiments, about 4%, by weight of the layer dough.

In another aspect, a laminated dough of the disclosure is particularly advantageous because it prepares a desirable laminated baked product that has a baked specific volume of at least 4 cc/g. In another representative embodiment, a baked product can have a baked specific volume of about 4 cc/g to about 6 cc/g.

In another aspect, a laminated dough of the disclosure is that it does not require a traditional proofing step either before freezing or before baking. Rather, the laminated dough is removed from the freezer and placed within a retarder to thaw and partially proof with minimal skill or observation. The elevated level of yeast in the dough increases the leavening rate during thawing, therefore eliminating the need for a distinct proofing step in a proof box before baking. Laminated dough of the present disclosure is especially advantageous in the large-volume food service industry because retarders are common in these operations and only minimal skill and intervention is needed to produce a desirable product. Therefore, the laminated dough of the invention can be left in the retarder unattended to thaw and expand overnight when the facility, such as a bakery, is not in use, making it an effective way to utilize down time. That is, a laminated dough of the disclosure does not need to be proofed in a separate step from thawing and/or baking, while still providing a desirable baked product.

### BRIEF DESCRIPTION OF THE DRAWINGS

FIG. 1 depicts a method for preparing a baked product from a laminated dough product according to the prior art.

FIG. 2 depicts a method for preparing a baked product from a laminated dough product according to an embodiment of the invention.

### DETAILED DESCRIPTION

Advantageously, the laminated dough of the invention does not require a traditional proofing step before freezing or baking. It is especially advantageous in the large-volume (mass production) food service industry. There, because retarders are commonly used in the process of making laminated baked products in the operations, minimal skill is needed to produce a desirable product. Retarders, unlike proof boxes, are relatively easy to use and do not require constant observation when a food product is placed within, because the retarder maintains a constant, pre-programmed temperature with slight variations of only a few of degrees. The laminated dough of the invention can be left in the retarder unattended to thaw and expand, such as overnight when the food service facility is typically closed, utilizing the down time of the facility, and better utilizing the operators' time. Therefore, the laminated dough product of the present disclosure minimizes the skill needed to prepare a desirable baked product from a laminated dough product by eliminating sensitive, skill-intensive steps, such as, proofing within a proof box. Eliminating the high-error proofing step reduces the variability of the baked product's size, color, and/or flavor, as well as, preparation time, while utilizing facility down time and maximizing operators' time.

In the food service industry, such as, for example, cafeterias and commercial bakeries, business decisions regarding baked-product choices are typically based on the quality of the food product, as well as, the efficiency and ease of preparation. The quality of the food product can be measured by a variety of quality characteristics, including visual appearance, consistency of the baked product, and taste of the baked product. A laminated dough product of the disclosure bakes into, for example, a finished croissant that is golden brown, with a flaky, moist consistency and has a freshly baked taste.

It has been found that a laminated dough of the disclosure is particularly desirable because it can prepare a laminated baked product that has a baked specific volume of at least 4 cc/g, preferably about 4 cc/g to about 6 cc/g, and more preferably about 4.5 cc/g to about 5.5 cc/g. Surprisingly, the laminated dough produces such desirable results even if it is not fully preproofed before freezing or baking, but rather is partially proofed simultaneously during thawing. No separate and distinct, proofing step, such as in a proof box, is required. By comparison, conventional frozen croissant dough, designed to be thawed and proofed, would provide a baked product having a specific volume of 1.8 to 2.8 when baked as freezer-to-oven (i.e., according to the process described herein, and without a proofing step).

The efficiency of preparation of such a baked product is also important within the food service industry, as it serves to reduce preparation time, in addition to reducing the level of skill necessary to produce a desirable product. The laminated dough product of the present disclosure is efficient in that a frozen laminated dough product can be placed directly into the retarder and subsequently into an oven requiring no separate full or distinct proofing step because partial proofing is accomplished during thawing, due to the increased yeast levels. The gas produced during thawing is then effectively held within the dough by the high gluten content, resulting in a product with higher baked specific volume than baked products prepared by conventional means. Thus, time and training costs are reduced compared to standard baked product preparation.

Typically, a representative laminated dough product of the invention, comprises alternating layers of shortening and layer dough, where the laminated dough product includes flour, water, a water-binding agent, a leavening agent, and a fat source. The laminated dough product can also contain one or more of several additional ingredients, such as, for example, dough stabilizing agents. The laminated dough product can also include from about 8 to about 600 layers of shortening and possibly about 16 to about 200 layers of shortening, although more or less layers can be done, depending on the desired final product. A shortening layer generally comprises shortening as further described below. A layer dough can include a dough prepared from flour, water, a water-binding agent, and a leavening agent. Within a laminated dough product, the shortening layers alternate with dough layers. Hereinafter, “laminated dough product” refers to the total composition of layer dough and shortening, “layer dough” refers to only the dough composition without the shortening layers, and “baked product” refers to the final baked product prepared from the laminated dough product.

The laminated dough of the disclosure includes a grain constituent that contributes to the structure of the dough. Wheat flour is a grain constituent that is frequently used in baked goods. Suitable flours can include hard winter and spring wheat flours, red, white, refined, whole grain, and other suitable flours. Most of these flours have protein ranges of about 10 weight percent to about 16 weight percent. A high protein flour (for example, a flour containing about 12 to about 16 weight percent protein) is preferred for use in the laminated dough. Alternatively, flours can be supplemented with a protein supplement, such as, gluten, for example, when the protein content of the flour is lower than desired. As described in more detail herein, the use of a protein supplement will often be determined based upon the desired total protein content of the laminated dough. In yet another embodiment, soft wheat flour or lower protein flours can also be used. A laminated dough of the disclosure may not require an artificial flour that has modified starch (e.g., cross-linked starches derived from maize or tapioca).

A laminated dough of the disclosure generally includes an amount of flour effective to provide structure to the layer dough and to provide desirable layer dough consistency. The amount of flour should be sufficient to provide a moist layer dough with the ability to expand while retaining the structure of a distinct dough layer when combined with shortening layers.

As described herein, the flour includes moisture and protein. Thus, the flour contributes to the moisture content of the laminated dough, as well as, the total protein content of the laminated dough. The flour amounts described above are based on flour having about 12% to about 14% moisture, about 12% to about 14% wheat protein, and about 0.4% to about 0.6% ash, as calculated based upon the weight of flour. One skilled in the art would understand that flour amounts suitable for use with a laminated dough of the disclosure can vary depending upon the characteristics of flour used. For example, when a flour with a lower moisture and/or protein content is used, the percentages given above will vary.

A laminated dough of the invention includes water which can act as a plasticizer, a leavening agent, or both. The total amount of plasticizers (e.g., the amount of water from all sources) should be effective to provide a desirable dough consistency suitable for a laminated dough.

As a plasticizer, water gives extensibility to the layer dough, allowing the layer dough to move and stretch. Desirable extensibility facilitates the laminated dough of the disclosure to be baked into a product having a desirable specific volume. A desirable specific volume of a laminated baked product according to the disclosure is at least 4 cc/g, and can be about 4 cc/g to about 6 cc/g, or even about 4.5 cc/g to about 5.5 cc/g. Moreover, water can facilitate the leavening of a laminated dough of the disclosure by forming steam, which acts as a leavening agent.

The amount of water in the layer dough can vary depending upon such factors as the amount of plasticizers (i.e., the amount of moisture provided by other sources than the water in the layer dough) and dry ingredients used in the formulation, the humidity of the processing conditions, the length of processing time, and the like. The total amount of plasticizers in the layer dough should be sufficient to provide a moist layer dough with the ability to expand while retaining the structure of a distinct dough layer when combined with shortening layers.

Typically a laminated dough of the disclosure includes flour and water in a flour-to-water ratio in a range of about 1:1 to about 2.5:1, or about 1.25:1 to about 1.75:1, and or about 1.4:1 to about 1.5:1, based on the weight of the layer dough only.

A laminated dough of the disclosure can include a water-binding agent which contributes to the hydration of the dough. A water-binding agent can improve the development of the layer dough by improving the resistance of the layer dough to shearing during mixing. While not wishing to be bound to any particular theory, it is believed that a water-binding agent allows the laminated dough to retain high amounts of water and to expand during baking. The water-binding agent releases water during the baking process, thereby allowing the laminated dough to expand. The amount of water-binding agent in the laminated dough is present in amounts effective to provide desirable baking development and desirable frozen stability. As contemplated in the disclosure, the amount of water-binding agent should be sufficient to absorb the amount of water needed to prepare a desirable laminated baked product by providing a moist layer dough with the ability to expand while retaining the structure of a distinct dough layer when combined with shortening layers.

Water-binding agents suitable for use in the laminated dough include, gelling agents and thickening agents. Gelling agents suitable for use include any compound that can form a gel. The gelling agent can be proteinaceous or non-proteinaceous. Examples of suitable gelling agents can include such gel-forming proteins, such as, gelatin, agar, hydrolyzed gelatin, gelatin precursors such as collagen, and the like. Thickening agents suitable for the laminated dough include compounds that can increase the viscosity of a medium when the compound is dispersed in water. Examples of suitable thickening agents include, but are not limited to gums, such as, for example, guar gum, xanthan gum, cellulose gum, gum arabic, and the like. Non-limiting examples of suitable non-proteinaceous thickening agents include pectin, alginate, carrageenan, carboxymethyl cellulose, methyl cellulose, hydroxypropyl cellulose, hydroxypropylmethyl cellulose, and the like. In an embodiment of the laminated dough, the water-binding agent is a combination of guar gum and pectin.

Commercially available gelling agents usefull in the laminated dough are those packaged with additional enzymes, such as, for example, GENU® FREEZE (Copenhagen Pectin A/S, Denmark) and GENU® FOOD GUM X6021 (Copenhagen Pectin A/S, Denmark). These gelling agents also include hemicellulases, which can also increase absorption by solubilizing insoluble pentosans. A laminated dough can also include an amylase, such as, one that includes any enzyme that can hydrolyze O-glucosyl linkages in starch, glycogen, and related polysaccharides. An example of amylase includes α-amylase. A pectin-enzyme blend can be, for example, an enzyme blend available from Danisco Cultor under the product number TS-B820, or an alginate-enzyme blend, also available from Danisco Cultor under product number TS-B821.

Leavening agents are used in laminated dough formulations to increase the volume and alter the texture of a baked product prepared by the laminated dough. Typically, the leavening agent saturates the layer dough with carbon dioxide and creates nuclei for leavening gases. Leavening agents suitable for use in a laminated dough of the disclosure include air, steam, yeast, and the like.

The leavening agent should be present in an amount that is effective to leaven a laminated baked product prepared from the laminated dough of the disclosure during thawing without requiring a distinct proofing step. A preferred leavening agent is yeast. Yeast as the leavening agent, provides a variety of desirable qualities, such as, for example, specific volume, flavor, and texture. Compressed yeast can be present within the layer dough in an amount of about 4% to about 6%, or about 4% to about 5% based on the total weight of the layer dough. The amount of yeast used according to the disclosure is sufficient to provide desirable flavor, oxidation, and texture in the baked product. When the leavening agent is used in combination with water, these percentages can vary as water provides steam-initiated leavening.

The laminated dough formulation also typically includes sugar and salt. Salt can enhance the flavor of a baked product prepared from a laminated dough, impart toughness to the gluten, and provide strength to the crumb. Salt can be present in an amount effective to provide a desirable flavor. Sugar can also enhance the flavor of a baked product prepared from a laminated dough of the disclosure. Sugar acts as a substrate for yeast and as a starting material for the Maillard reaction, which facilitates color formation of the crust. The amount of sugar used in the product will vary depending upon such factors as the overall sweetness of the product to be formed by the laminated dough. In an embodiment of the disclosure, the sugar can comprise a combination of granulated sugar and high fructose corn syrup. Other suitable sugar types can include honey, and the like, or combinations thereof.

Inventive composition of a laminated dough can also include additives, for example, emulsifiers, dough-developing agents, nutritional supplements, flavorings, shelf-life stabilizers, organic acids, dough stabilizing agents (e.g., oxidizers), and the like. Additives can modify texture or any number of characteristics of the laminated dough of the disclosure or a laminated baked product resulting therefrom.

An emulsifier can influence the texture and homogeneity of the layer dough mixture, increase dough stability, and improve the eating quality of a laminated baked product. Representative emulsifiers can be nonionic surfactants, anionic surfactants, and/or cationic surfactants. Suitable emulsifiers can also include, for example, lecithin, mono- and diglycerides of fatty acids, propylene glycol monoesters and diesters of fatty acids, glyceryl-lacto esters of fatty acids, ethoxylated monoglycerides and diglycerides, sodium stearoyl lactylate, diacetyl tartaric acid esters of monoglycerides, and the like. In one embodiment, a laminated dough formulation includes emulsifiers selected from sodium stearoyl lactylate, diacetyl tartaric acid ester of monoglycerides and diglycerides (DATEM), or combinations thereof.

A dough-developing agent can enhance the elasticity or extensibility of a dough. Any number of dough-developing agents can be used including, for example, azodicarbonamide, ascorbic acid, sodium bisulfite, potassium bromate, benzoyl peroxide, and organic acids, such as, potassium sorbate or salts of organic acids. In addition, enzymes such as transglutaminase or lipoxygenase can be used. One example of such an enzyme is a transglutaminase, amylase and hemicellulase enzyme product available from Rohm Enzyme GmbH, under product name “VERON CLX.” In embodiments of the invention, a dough-developing agent can be azodicarbonamide, ascorbic acid, or a combination thereof.

A nutritional supplement can also be added to a laminated dough of the invention, such as vitamins, minerals, proteins, and the like. Examples of nutritional supplements include thiamin, riboflavin, niacin, iron, calcium, and the like.

Flavorings, such as, for example, sweeteners, spices, and specific flavorings can be added to a laminated dough of the disclosure. Sweeteners include, for example, honey, regular and high fructose corn syrup, sucrose (cane or beet sugar), dextrose, and the like.

Shelf-life stabilizers, such as, for example, preservatives and mold inhibitors can be added to a laminated dough of the formulation. Suitable shelf-life stabilizers include, for example, sodium salts of propionic or sorbic acids, as well as, emulsifiers such as sodium stearoyl lactylate, and the like.

Dough stabilizing agents, such as, oxidizers can be added to the laminated dough of the disclosure to provide shelf life stability. Examples of suitable oxidizers include ascorbic acid, azodicarbonamide, bromate, and the like.

A laminated dough of the disclosure can be free of or have very low levels, such as, an amount of less than 15 ppm, of relaxing agents that facilitate a dough's resistance to mechanical stresses, such as, mixing, sheeting, and the like. Relaxing agents can adversely affect the shelf life of frozen dough, as well as, specific volume. Relaxing agents can include reducing agents, such as, for example, cysteine, bisulfite, sorbate, and the like. In one embodiment, a laminated dough of the disclosure is free of cysteine. In another embodiment, the laminated dough includes an amount of dry yeast as a relaxing agent.

A laminated dough of the present disclosure can have a higher total fluidizer content than that of conventional laminated dough. As described herein, the total fluidizer content includes the total amount of moisture and fat in the laminated dough. The total fluidizer as used herein, refers to the laminated dough, i.e., including the layer dough and shortening layers. The moisture of the total fluidizer content can be provided by any ingredient that includes moisture, including water, high moisture components (e.g., liquid egg, milk and cream yeast), as well as, ingredients provided in powder form (e.g., flour). The fat of the total fluidizer content can be provided by fat sources, such as, shortening, butter, oils, and the like.

The total fluidizer content is typically either calculated or analyzed with respect to the laminated dough after formation of the laminated dough, and prior to baking. In the context of automatic manufacturing or large-volume manual manufacturing, moisture and fat can also enter the formula by addition of “rework” or recycled cutting of imperfect product. Typically, the total fluidizer content of the laminated dough of the disclosure is at least about 40%, based on the total weight of the laminated dough product.

As used herein, the “total protein content” of a laminated dough is the total amount of protein in the laminated dough, calculated as a weight percentage of the laminated dough. The total protein content includes protein from all sources, including flour and gluten (e.g., wheat protein), as well as, yeast, milk, eggs, and the like. The total protein content of the laminated dough preferably provides structure to the dough and excellent gas holding capacity, and can contribute to a baked product prepared from a laminated dough of the disclosure having a crisp, brown outer crust, as well as, a tender interior that is moist but not doughy, and an increased baked specific volume, as compared to products (e.g. croissants) prepared by traditional means.

The total protein content of the laminated dough is achieved by including a protein supplement, preferably vital wheat gluten to the layer dough. As used herein, a “protein supplement” means a source of protein in addition to the protein provided by the main flour component of the dough. Other suitable protein supplements can include, for example, proteins resulting from amino acids, such as, for example, glycine, alanine, leucine, isoleucine, valine, phentolamine, turicine, tryptophan, proline, methionine, cystine, serine, threonine, asparagine, glutamine, histidine, aspartic acid, glutamic acid, lysine, and arginine, and combinations thereof. Other suitable protein supplements include, for example, α-keratin, collagen, fibroin, sclerolin, myosin, actin, carboxypeptidase, trypsin, ovalbumin, casein, and the like and combinations thereof. Other suitable protein supplements include, dairy protein, egg protein, wheat protein, or a combination thereof. Examples of suitable dairy proteins include whey, soy protein, caseinate, buttermilk, buttermilk solids, and nonfat dry milk. Examples of suitable egg proteins include, albumin. Examples of suitable wheat proteins include, gluten or those derived from flour.

A laminated dough of the invention can include a protein supplement, such as, vital wheat gluten, at a minimum of about 3%, in a range from about 3.5% to about 4.5%, or from about 4%, by weight of the layer dough. One of skilled in the art will appreciate that the amount of protein supplement included will vary depending upon the amount of protein included in the flour, and the desired total protein content of the laminated dough. The total protein content should be an amount sufficient to provide a layer dough that results in a baked product with a desirable texture that is not either too tough and crumbly, or too gummy and doughy.

The laminated dough of the invention comprises a plurality of alternating layers of dough and roll-in fat, or shortening, which can be a solid shortening. As used herein, “solid shortening” can refer to a solid fat (e.g., hydrogenated vegetable oil), a solid fat combined with water (e.g., margarine), butter, animal fat (e.g., beef tallow or lard), or combinations thereof Preferably the shortening in the shortening layers includes butter.

The shortening contained within the shortening layers typically is present in a range of about 5% to about 30%, and can be about 20%, based on the total weight of the laminated dough. These amounts do not take into consideration the amount of shortening, if present, in the dough that was dispersed during dough mixing. As discussed herein, the shortening of the shortening layers also contributes to the total amount of fat in the laminated dough, and thus contributes to the total fluidizer content of the laminated dough.

A laminated dough product of the invention can generally be prepared by mixing the above-described ingredients to form a layer dough, to provide flour-water layers, laminating in the shortening layers, shaping the laminated dough, and freezing the laminated dough. One skilled in the art having read the specification would understand that the mixing and laminating steps are generally performed using accepted technique for the product to be made, for example, croissant or the like.

A layer dough suitable for providing the laminated dough layers in a laminated dough of the disclosure can be prepared according to methods known in the art. In one embodiment, a layer dough can be prepared by combining all ingredients and mixing until the layer dough is fully developed. Fully developed refers to transforming the mixture into a cohesive mass, such that, the layer dough is substantially homogenous and soft.

A layer dough can be mixed in any mixer suitable for combining the ingredients and mixing until the layer dough is fully developed. An example of a suitable mixer includes a vertical mixer available from the Hobart Corp. of Troy, Ohio. During mixing, the layer dough is desirably maintained at a temperature that maintains the structure of the layer dough to facilitate handling of the layer dough. Typically, the temperature can be in a range of about 50° F. to about 70° F. To maintain the desirable temperature, the water added should be at a temperature suitable for maintaining the dough at the desirable temperature. The layer dough is mixed at a speed and time that are suitable for fully developing the layer dough. After mixing, a layer dough desirably has a temperature of about 50° F. to about 70° F., preferably about 55° F. to about 65° F.

Upon being mixed to full development, a layer dough desirably has a consistency of about 400 Brabender units (B.U.) to about 1200 B.U., preferably about 800 B.U. to about 1000 B.U., more preferably about 850 B.U. This layer dough consistency can be determined by a Farinograph measurement. Farinograph measurements are known to one of skill in the art and measures a dough's resistance against mechanical improvement, such as, mixing. A Farinograph measurement involves determining the viscosity of the dough. A layer dough prepared for a laminated dough of the disclosure is typically softer than the dough used in known croissants, which have a consistency of about 900 B.U. to about 1250 B.U., typically 1000 B.U. to 1200 B.U.

In another embodiment, a layer dough can be prepared by first preparing a preferment or sponge. This layer dough can be prepared according to the method described above with the following modifications. To prepare a sponge, water at a temperature of about 60° F. to about 65° F., sugar, and yeast are mixed until the yeast substantially dissolves and then flour is added, and the mixture of water, sugar, yeast, and flour are mixed until the flour is incorporated. The sponge is then placed at about room temperature for an amount of time effective to develop active fermentation and approximately double in size. In one embodiment, the sponge is about 15 to 20% by weight of the laminated dough of the disclosure. The sponge can be added to all remaining ingredients, and all ingredients can be mixed until fully developed. The mixing procedure is carried out in the same manner as for the layer dough prepared without a sponge.

In yet another embodiment, a layer dough can be prepared by first preparing a sponge as described above, except the sponge does not include flour. Regardless of the method of preparing the layer dough (e.g., straight dough method or by preparing a preferment or sponge), the final laminated dough is preferably maintained under conditions suitable to avoid proofing of the dough. For example, the laminated dough and ingredients can be maintained at a temperature at which yeast is inactive, thereby avoiding proofing of the dough during the process of preparing the dough.

According to the disclosure, roll-in shortening, butter, or other fat source is applied onto the surface of the layer dough to prepare a sheet dough. This is followed by a folding process, completely enveloping the fat within the layer dough while attempting to maintain both the layer dough and roll-in fat as distinct layers. The sheet dough can be repeatedly folded and sheeted, using techniques know in the art, to provide a desired number of shortening layers in the laminated product. The term “laminating” as used in the context of this disclosure includes the incorporation and maintenance of layers of shortening between adjacent layers of dough. Shortening can be laminated into the dough to provide a laminated dough having about 8 to about 600 shortening layers, preferably about 16 to about 200 shortening layers, and more preferably about 24 to about 100 shortening layers.

Between sheeting steps, the laminated dough can be refrigerated to avoid having the shortening melt into the layer dough and to avoid sheeting without tearing. The shortening is applied as either a premeasured proportion of each dough piece or extruded onto sheeted dough. After sheeting, the laminated dough is cooled to a temperature suitable for accepted technique for a croissant. In one embodiment, the shortening that is softened and sheeted includes butter. After completion of the folding and sheeting sequence, the laminated dough can be rolled and shaped.

The laminated dough can then be laminated and formed into desirable shapes, such as, the shapes typically used for croissants, cinnamon rolls, Danish pastries, twirls, twists, etc. In one embodiment, a laminated dough of the disclosure is formed into a croissant by being run through a croissant make-up machine, such as, for example, a make-up machine manufactured by Rondo of Burgdorf, Switzerland. The formed laminated dough can be transferred to any container suitable for freezing, preferably in bulk packs to accommodate large-volume food service and/or supercenter customers. The laminated dough does not need to be stored in a package having a modified atmosphere.

Referring to FIG. 2, a method for preparing a baked product from a laminated dough product according to an embodiment of the invention is shown generally at 200. After a laminated dough is formed into a desirable shape (and optionally deposited into a container), in freezing step 202, the laminated dough is frozen to a temperature suitable for shipping the laminated dough and/or handling for future use. The dough is preferably frozen quickly and completely as possible. A laminated dough can be frozen at a temperature of about 0° F. to about −35° F.

To prepare a baked finished product from a laminated dough made according to the present disclosure, the laminated dough is removed from the freezing conditions 202 described above. In thawing step 204, the frozen laminated dough product(s) can be placed on any container, such as, trays, pans, and the like, and then placed in a retarder, cooler, refrigerator, or the like. In a preferred embodiment, the laminated dough product is covered to avoid excessive drying of the laminated dough product. Retarders are commonly available in large-volume food service operations and can accommodate large volumes of food products at one time. In general, the interior environment of the retarder has a temperature of about 35° F. to about 45° F., preferably around 40° F.

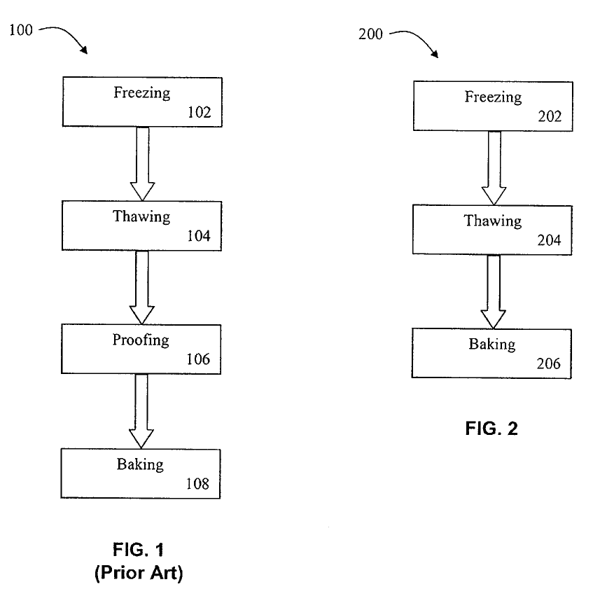

The laminated dough products can be left unattended in the retarder, with no need to monitor humidity and/or temperatures, as in a traditional proofing step. Therefore, less skill is required in the preparation of the baked laminated dough product. The laminated dough product is left in the retarder for about 12 hours to about 24 hours. During this time period, the laminated dough product thaws and activates the leavening agent. In a preferred embodiment, the laminated dough product increases at least two times in volume from the frozen laminated dough product, resulting in a partially proofed laminated dough product ready for baking. Therefore, thawing step 204 combines the thawing step 104 and proofing step 106 of FIG. 1, requiring less time and resulting in more consistent handling and preparation of the baked laminated product (less variability due to variation in baking skill level). In a preferred embodiment of the present disclosure, the thawed laminated dough product is set out at ambient conditions for up to about 1 hour upon removal from the retarder and before baking.

A laminated baked product of the disclosure can be prepared without a traditional, distinct proofing step before baking the laminated dough. That is, the laminated dough can be removed from the retarder in thawing step 204 and be baked immediately in an oven in baking step 206, without undergoing a separate proofing step. In one embodiment, after removal from the retarder, the thawed laminated dough product can be optionally set out for partial proofing at ambient conditions before baking, where baking provides for substantially complete proofing. In another embodiment, before baking step 206, a laminated dough of the disclosure can be brushed with a glaze, such as, an egg wash (egg and water). A thawed croissant can then be baked at an appropriate baking temperature of about 325° F. to about 400° F. for about 16 minutes to about 24 minutes.

As described above, method 200 for preparing a baked product from a laminated dough product reduces the preparation time as compared to standard methods of preparation, such as, method 100 depicted in FIG. 1. For example, referring to FIG. 1, a baked product is prepared by thawing the laminated dough for about 14 hours at about 40° F., resting at ambient conditions for about 15 minutes, proofing for about 90 minutes in a proof box (about 90° F. and about 75% relative humidity), and baking for about 15 minutes in an oven for a total preparation time of about 16 hours. Referring to FIG. 2, on the other hand, a baked product is prepared by method 200 by thawing the laminated dough for 14 hours in a retarder at about 40° F., optionally resting at ambient conditions for about 60 minutes, and baking in an oven for about 15-20 minutes for a total preparation time of just over about 15 hours. The laminated dough of the invention reduces preparation time of a baked product, even with the optional resting step by eliminating the need of a separate proofing step. What is not apparent from the preceding example is that the finished product of method 200, is much more uniform in size and color than the finished product of method 100. Much of this variability is reduced by the elimination of the uncertainty surrounding a proofing step.

This disclosure will be further characterized by the following example(s). Variations within the scope of the disclosure will be apparent to those skilled in the art.

### EXAMPLE 1

### General Range of Formulations for a Croissant Prepared from a Laminated Dough of the Disclosure

Layer Dough Composition

| Ingredient | Weight % of Dough |
|---|---|
| Flour | 47–54 |
| Water | 28–35 |
| Butter | 0–2 |
| Yeast | 3–5 |
| Vital Wheat Gluten | 3–5 |
| Sugar | 2.5–5 |
| Salt | 0.08–1.1 |
| Water-binding agent | 0–1 |
| Emulsifier | 0–0.3 |
| Dough developing agent | 0–0.003 |

Total Laminated Dough Product Composition

| Ingredient | Total Weight Percent |
|---|---|
| Laminated Dough | 70–80 |
| Composition | |
| Shortening (Butter) | 20–30 |

To prepare a croissant from a laminated dough of the disclosure, the following procedure was used:

The butter to be used in the butter layers was softened by mixing the butter. The softened butter was placed in the middle of parchment paper, covered with parchment, and sheeted into a slab. A layer dough was subsequently prepared as follows. All ingredients except for the butter for the shortening layers, were mixed until blended and fully developed. The layer dough was placed in a sheeter and sheeted into a slab.

At this point, the shortening is applied and the additional layer dough is folded over and sheeted to produce layers as follows. The slab of butter was placed in the middle of the slab of layer dough. The layer dough was wrapped around the butter. The shortening and layer dough was sheeted was and then lapped multiple times until the desired number of layers were formed. The final croissant weighed about 55 g to about 60 g and had a specific volume of about 1.0 cc/g to about 1.2 cc/g.

The croissants were blast frozen to an internal temperature of 10 F or lower and placed in a freezer for storage overnight. The croissants were then thawed in a retarder at about 40° F. for about 14 hours. It is noted that croissants prepared according to the formulations in Example 1 provide for the elimination of the proofing step. The elimination of the proofing step allows not only for significant time savings but also for reduced product variability in terms of volume and texture of the final baked product. The croissants were baked in an oven preheated to about 350° F. for about 16 minutes to about 24 minutes. The final baked product had a golden brown color and a specific volume of about 5.5 cc/g. The cell structure was typical of a croissant.

It should be noted that, as used in this specification and the appended claims, the singular forms “a,” “an,” and “the” include plural referents unless the content clearly dictates otherwise. Thus, for example, reference to a composition containing “a water-binding agent” includes a mixture of two or more water-binding agents.

Although embodiments of the disclosure have been described above, it is not limited thereto, and it will be apparent to persons skilled in the art that numerous modifications and variations form part of the present disclosure insofar as they do not depart from the spirit, nature, and scope of the claimed and described disclosure.

What is claimed:

1. A laminated dough product comprising:
a plurality of alternating layers of layer dough and shortening, said layer dough having at least flour, water, yeast, and vital wheat gluten, wherein said vital wheat gluten is from about 3% to about 5% by weight percent of the layer dough,
wherein a baked product is prepared from said laminated dough product by freezing said laminated dough product, thawing said laminated dough product in a retarder, and baking said laminated dough product, without the need for proofing said laminated dough in a proof box.

2. The laminated dough product according to claim 1, wherein the yeast is present in an amount of about 4% to about 6% based on the total weight of the layer dough.

3. The laminated dough product according to claim 1, wherein the shortening layers comprise a solid fat, such as, hydrogenated vegetable oil, a solid fat combined with water, such as, margarine, butter, animal fat such as beef tallow or lard, or combinations thereof.

4. The laminated dough product according to claim 1, wherein the shortening layers comprise butter.

5. The laminated dough product according to claim 1, wherein the shortening layers comprise shortening in an amount of about 15% to about 25% based on the total weight of the laminated dough.

6. The laminated dough product according to claim 1, wherein the laminated dough product is used in food service facilities.

7. The laminated dough product according to claim 1, further comprising at least one emulsifier, dough-developing agent, water-binding agent, flavoring, or a combination thereof.

8. The laminated dough product according to claim 1, wherein the laminated dough comprises a total fluidizer content at a minimum of 40% based on the total weigh of the laminated dough.

9. A baked product prepared from the laminated dough product of claim 1.

10. The baked product according to claim 9, wherein the baked product has a baked specific volume of about 4 cc/g to about 6 cc/g.

11. A method of producing a baked product from a laminated dough product comprising:
preparing a laminated dough product comprising a plurality of alternating layers of dough and shortening, said dough having at least flour, water, yeast, and vital wheat gluten, wherein said vital wheat gluten is from about 3% to about 5% by weight percent of the dough;
freezing said laminated dough product;
thawing said laminated dough product in a retarder wherein the specific volume of the laminated dough product increases by at least 2 times in the retarder;
baking said laminated dough product upon removal from said retarder without the need for proofing said laminated dough in a proof box.

12. The method according to claim 11, wherein said laminated dough product is used in food service facilities.

13. The method according to claim 11, wherein said laminated dough is stored in ambient conditions for about one hour prior to baking after thawing in said retarder.

14. The method according to claim 11, wherein the baked product has a baked specific volume of about 4 cc/g to about 6 cc/g.

15. The method according to claim 11, wherein said laminated dough product comprises at least 24 alternating layers of dough and shortening.

16. A method for preparing a laminated dough product from a frozen laminated dough comprising:
placing a laminated frozen dough product within a retarder until a specific volume of a retarded dough product has increased at least about 2.0 times; and
baking the retarded dough product to form a baked product having a Baked Specific Volume exceeding at least about 4.0 cc/g.

17. The method of claim 16, wherein the steps of placing and baking are performed in less than 16 hours.

18. The method of claim 16, where the step of placing the laminated frozen dough product within the retarder is accomplished without observation by an operator.

19. The method of claim 16, further comprising:
resting the retarded dough product at ambient temperature for up to 60 minutes.

20. The method of claim 19, wherein the steps of placing, baking and resting are performed in less than 16 hours.
